(19) United States
(12) Patent Application Publication
(10) Pub. No.: US 2003/0011815 A1
(43) Pub. Date: Jan. 16, 2003

(54) Image forming apparatus, image forming system and image forming method

(75) Inventor: Koji Kita, Kanagawa (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/188,399

(22) Filed: Jul. 2, 2002

(30) Foreign Application Priority Data
Jul. 11, 2001 (JP) 210336/2001

(51) Int. Cl. B41J 1/00; G06K 1/00; G06F 15/00

(52) U.S. Cl. 358/1.15

(57) ABSTRACT

An image forming apparatus connecting a information processing apparatus via a network, comprising: a scanning section to read a document to obtain an image data; a storing section to store the image data; an operating section having a inputting section to input processing information, and a displaying section; a printing section to print a printing image based on the image data stored in the storing section; and a controlling section comprising: a function to transfer the image data and an initial processing information imputed by the inputting section to the information processing apparatus via the network; a function to receive a preview image data from the information processing apparatus; a function to display a preview image based on the preview image data on the displaying section; and a function to transfer a reprocessing information imputed by the imputing section with respect to the preview image to the information processing apparatus.

### FIELD OF THE INVENTION

The present invention relates to an image forming apparatus, an image forming system and an image forming method, and in particular, to an image forming apparatus, an image forming system and an image forming method wherein image data are transmitted through a network.

### BACKGROUND OF THE INVENTION

There has been provided an image forming system used under the network circumstances in which an image forming apparatus is connected to the network.

The image forming system is composed of, for example, an image forming apparatus such as a digital copying machine and an information processing apparatus such as a personal computer or a work station which instructs scanning (reading) and printing of images for the image forming apparatus, which are connected with each other. It is further possible to take an arrangement wherein a plurality of image forming apparatuses are connected to the network.

In the image forming system of this kind, when various kinds of image processing are required to be conducted on image data obtained by scanning a document in the image forming apparatus, for example, it is also possible to transmit image data to an information processing apparatus connected to the network so that image processing is carried out in the information processing apparatus and to return the image data to the image forming apparatus so that printing is conducted, namely, image forming is conducted on the image forming apparatus, although it is possible to conduct image processing by utilizing functions in the image forming apparatus.

In the conventional image forming system, however, there have been the following problems.

Namely, in the conventional image forming system, when conducting image processing, with another apparatus connected to the network, on image data stored in an image forming apparatus, there have been transmitted image data each time the image processing was conducted.

Accordingly, when an operator is not satisfied with an image in the results of image processing conducted by the operator and is repeating image processing several times, image data travels back and forth on the network each time the image processing is conducted, resulting in a problem that a load on the network is increased and a transmission efficiency is worsened to affect other processing.

### SUMMARY OF THE INVENTION

The present invention has been achieved in view of the aforementioned point, and its object is to provide an image forming system composed of an image forming apparatus and an information processing apparatus that conducts image processing on image data, both apparatuses being connected with each other through a network, wherein a load on the network is lowered, and smooth operations can be conducted.

The above objects have been achieved by following structures.

Structure 1

An image forming apparatus capable of connecting a information processing apparatus via a network, the image forming apparatus comprising:

a scanning section to read an image on a document to obtain an image data;

a storing section to store the image data;

an operating section having a inputting section to input processing information, and a displaying section to display information;

a printing section to print a printing image based on the image data stored in the storing section; and

a controlling section comprising:

a function to transfer the image data and an initial processing information imputed by the inputting section to the information processing apparatus via the network;

a function to receive a preview image data from the information processing apparatus;

a function to display a preview image based on the preview image data on the displaying section; and

a function to transfer a reprocessing information imputed by the imputing section with respect to the preview image to the information processing apparatus.

Structure 2

The image forming apparatus of Structure 1, wherein the controlling section further comprising:

a function to receiving a processed image data from the information processing apparatus;

a function to store the processed image data into the storing section; and

a function to print a processed image based on the processed image data by utilizing the printing section.

Structure 3

An image forming system comprising an image forming section, an information processing section and a printing section, the image forming section, the information processing section and the printing section being connected via a network, the image forming section comprising:

a scanning section to read an image on a document to obtain an image data;

a storing section to store the image data; and

an operating section having a inputting section to input processing information, and a displaying section to display information,

wherein the image forming system comprises:

a function to transfer the image data and initial processing information inputted by the imputing section to the information processing section;

a function to process the image data based on the initial processing information to make a processed image data by the information processing section;

a function to make a preview image data based on the processed image data by the information processing section;

a function to transfer the preview image data to the image forming section;

a function to display a preview image based on the preview image data on the displaying section;

a function to transfer reprocessing information imputed by the imputing section with respect to the preview image to the information processing section;

a function to process the processed image data based on the reprocessing information to make a print image data;

a function to transfer the print image data to the printing section;

a function to printing a print image based on the print image data by the printing section.

Structure 4

The image forming system of Structure 3, wherein the image forming section and the printing section are installed in a image forming apparatus.

Structure 5

An image forming method utilizing an image forming system comprising an image forming section, an information processing section and a printing section, the image forming section, the information processing section and the printing section being connected via a network, the image forming section comprising: a scanning section; a storing section; and an operating section having a inputting section, and a displaying section, the image forming method comprising the steps of:

scanning an image on a document to obtain an initial image data;

storing the initial image data into the storing section;

inputting initial processing information by the inputting section;

transferring the initial image data and the initial processing information to the information processing section;

processing the image data based on the initial processing information to make a processed image data by the information processing section;

making a preview image data based on the processed image data by the information processing section;

transferring the preview image data to the image forming section;

displaying a preview image based on the preview image data on the displaying section;

inputting reprocessing information with respect to the preview image by the inputting section;

transferring the reprocessing information to the information processing section;

processing the processed image data based on the reprocessing information to make a print image data;

transferring the print image data to the printing section;

printing a print image based on the print image data by the printing section.

### BRIEF DESCRIPTION OF THE DRAWINGS

FIG. 1 is a block diagram showing the structure of an embodiment of an image forming system of the invention.

FIG. 2 is a block diagram showing the structure of digital copying machine 1 shown in FIG. 1.

FIG. 3 is a diagram showing a flow chart of operations of the digital copying machine 1 shown in FIG. 1.

### PREFERRED EMBODIMENTS OF THE INVENTION

An embodiment of the invention will be explained as follows, referring to the drawings. Incidentally, there will be explained an occasion wherein an image forming apparatus (image forming section) is a digital copying machine, and an information processing apparatus (information processing section) is a personal computer, in the present embodiment.

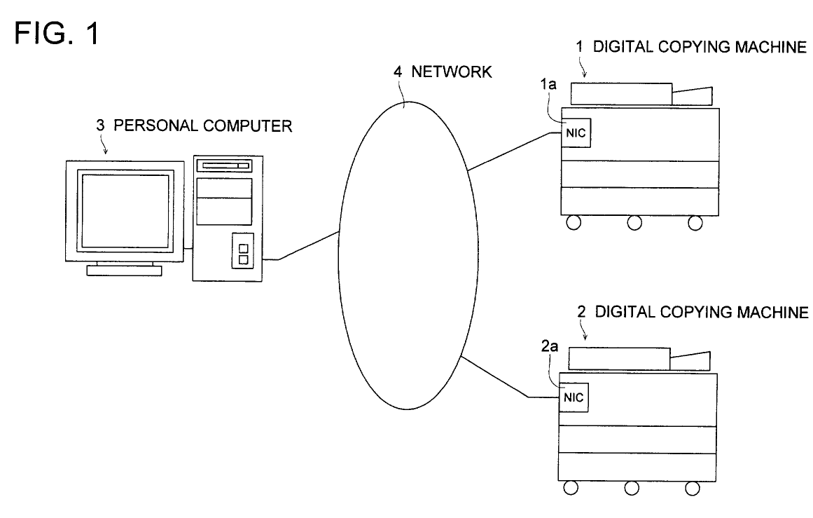

FIG. 1 is a block diagram showing the structure of an embodiment of an image forming system of the invention.

The present embodiment is structured to have two digital copying machines 1 and 2. Each of these two digital copying machines 1 and 2 can read (scan) a document and form (print) an image individually, and in addition to that, they can be connected to the network so that images obtained by the digital copying machine 1 through its reading is transmitted to the digital copying machine 2, and an image is formed by the digital copying machine 2, and vice versa.

These digital copying machines 1 and 2 respectively have NICs (network interface cards) 1a and 2a, and these NIC1a and NIC2a serve as an interface for network 4 to realize communication.

Further, the present embodiment is structured with network 4 to which personal computer 3 is also connected. This personal computer 3 can give instructions to the digital copying machines 1 and 2, concerning image reading, image forming and transmission of images. It can further transmit images stored in the personal computer 3 to the digital copying machine 1 or 2 so that an image may be formed on the digital copying machine 1 or 2, or it can transmit images obtained by the digital copying machine 1 or 2 through its reading to the personal computer 3 so that editing and storage may be conducted on the personal computer 3.

Further, in FIG. 1, the network 4 can be any of networks including LAN such as Ethernet (registered trademark), for example, and other various kinds of networks.

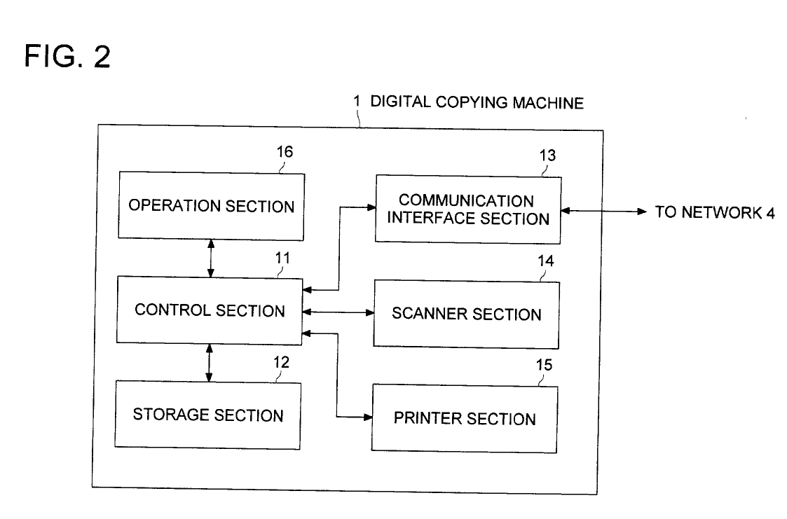

FIG. 2 is a block diagram showing the structure of digital copying machine 1 shown in FIG. 1.

Since both of the digital copying machines 1 and 2 shown in FIG. 1 are the same in terms of structure, digital copying machine 1 will be explained here as a representative of them.

The digital copying machine 1 is composed of control section 11 that controls all over, storage means 12 that stores programs and parameters which are needed for the control, communication interface section 13 which is an interface to be connected with network 4 and includes NIC1a, scanner section 14 for reading images from a document, printer section 15 that forms an image on paper, for example, and of operation section 16 equipped with an inputting section through which an operator operates digital copying machine 1 or conducts instructions and with a display section that displays information to the operator.

Next, operations in the present embodiment will be explained.

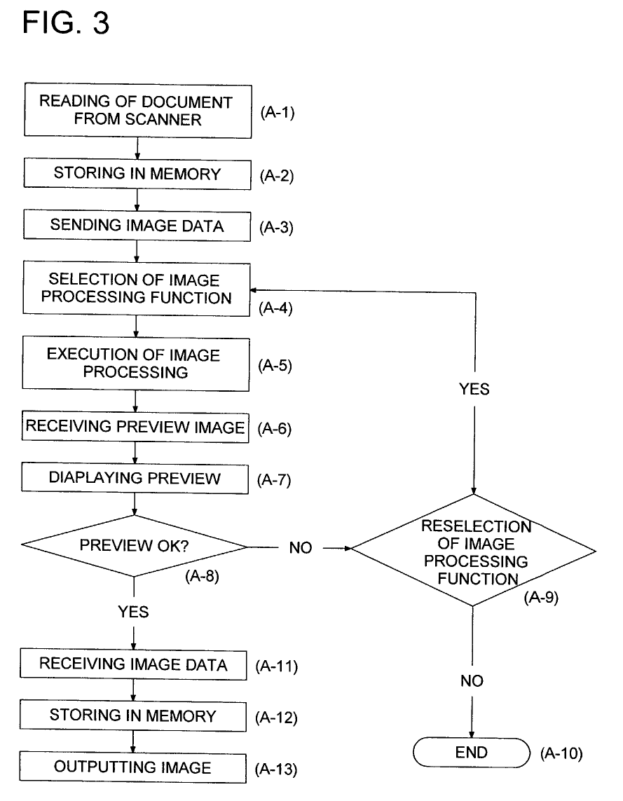

FIG. 3 is a diagram showing a flow chart of operations in digital copying machine 1 shown in FIG. 1.

In this case, there will be explained an occasion wherein image processing is conducted by personal computer 3 on image data obtained through reading of a document by digital copying machine 1.

First, images of a document is read by scanner section 14, and image data are obtained (A-1). The image data are stored in storage section 12 (A-2).

After that, when conducting image processing on image data thus obtained through reading, an operator operates operating section 16 to give instructions to digital copying machine 1 to carry out image processing. On the digital copying machine 1 which has received the instructions, image data are transmitted to an outer apparatus that is in charge of image processing, namely to personal computer 3 (A-3). As image data to be transmitted, it is either possible to transmit multi-density level data obtained by a scanner section through reading as they are without compressing image data for a plurality of pages, or possible to transmit a plurality of image data alone without transmitting job information data, although it is desirable to transmit job information data for controlling data-compressed image data of plural pages and image data of plural pages as one job.

Then, the operator specifies, by means of operation section 16, the conditions for parameters concerning the current image processing, and selects image processing function (A-4). This selected information is transmitted from digital copying machine 1 to personal computer 3 on which the received image data are subjected to image processing under the specified conditions (A-5). The image processing function includes, for example, a halftone dot processing function, imposition function and user stamp function. The imposition function is a function to make a layout of how pages need to be positioned in order to meet press, folding, and bindery requirement. In the case of the halftone dot processing function, a user can select the halftone dot processing function on the operation section and to select further a desired halftoning method. In this case, it is preferable for a preview image to make one that is a part enlarged after image processing. In the case of the imposition function, a user selects the imposition function on the operation section, and further specifies the number of pages to be developed on a surface. In this case, it is possible either to display only the outputting direction of one surface after imposition for the preview image, or to use a reduced image of the part imposed actually. In the case of the user stamp function, a user selects a user stamp function on the operation section, and further selects or inputs letters to be stamped. In this case, it is preferable for the preview image to make the image on which a stamp is pasted. There naturally exist image forming functions other than those given as examples.

After completion of image processing on personal computer 3, image data for a preview for displaying images after image processing are transmitted to digital copying machine 1. On the digital copying machine 1, the image data for a preview are received (A-6), and preview images are displayed on the display section provided on the operation section 16 based on the data (A-7). A preferable form of the image data for preview, for example, is one that is easily displayed on a display section provided on an operation section on the main body. When the display section serves also as Web browser function, the form may be either a png form or a jpeg form, and when the copying machine main body displays images directly through a display driver, data of an exclusive type is acceptable.

An operator observes a preview image to judge whether the result of the image processing is what the operator expected or not (A-8), and if the operator is not satisfied, it is possible for the operator either to try by changing conditions for image processing (A-9, A-4) or to end the processing (A-9, A-10).

When changing conditions to try in step (A-9), the flow returns to step (A-4), and an operator designates, by means of operation section 16, the conditions including parameters concerning the current image processing, and selects an image processing function to repeat the processing thereafter.

When an operator is satisfied with the result of image processing after observing a preview image in step (A-8), the operator inputs information to the effect into digital copying machine 1 by means of operation section 16, then, the digital copying machine 1 requests personal computer 3 to transmit image data after image processing, and the personal computer 3 which has received the foregoing transmits the image data after image processing to digital copying machine 1. The digital copying machine 1 receives the image data after image processing (A-11) and stores them in storage section 12 (A-12).

After that, in response to the instruction from the operator, outputting of an image, namely, printing of an image is conducted by printer section 15 based on image data stored in storage section 12 (A-13).

(Effect of the Invention)

As explained above, the invention makes it possible to provide an image forming system composed of an image forming apparatus and an information processing apparatus that conducts image processing on image data, both being connected by a network, wherein a load on the network is reduced and smooth operations can be conducted.

Namely, in the invention, when trying image processing several times by changing conditions, all the information processing apparatus has to do is just to transmit image data for a preview to the image forming apparatus, and all the image forming apparatus has to do is just to transmit image data to the image processing apparatus for the first one time. It is therefore possible to reduce data flowing through the network, and to confirm the output results in advance with the preview image, resulting in an effect that erroneous printing is reduced.

What is claimed is:

1. An image forming apparatus capable of connecting a information processing apparatus via a network, the image forming apparatus comprising:
a scanning section to read an image on a document to obtain an image data;
a storing section to store the image data;
an operating section having a inputting section to input processing information, and a displaying section to display information;
a printing section to print a printing image based on the image data stored in the storing section; and
a controlling section comprising:
a function to transfer the image data and an initial processing information imputed by the inputting section to the information processing apparatus via the network;
a function to receive a preview image data from the information processing apparatus;
a function to display a preview image based on the preview image data on the displaying section; and
a function to transfer a reprocessing information imputed by the imputing section with respect to the preview image to the information processing apparatus.

2. The image forming apparatus of claim 1, wherein the controlling section further comprising:
a function to receiving a processed image data from the information processing apparatus;
a function to store the processed image data into the storing section; and
a function to print a processed image based on the processed image data by utilizing the printing section.

3. An image forming system comprising an image forming section, an information processing section and a printing section, the image forming section, the information processing section and the printing section being connected via a network, the image forming section comprising:
a scanning section to read an image on a document to obtain an image data;
a storing section to store the image data; and
an operating section having a inputting section to input processing information, and a displaying section to display information,
wherein the image forming system comprises:
a function to transfer the image data and initial processing information inputted by the imputing section to the information processing section;
a function to process the image data based on the initial processing information to make a processed image data by the information processing section;
a function to make a preview image data based on the processed image data by the information processing section;
a function to transfer the preview image data to the image forming section;
a function to display a preview image based on the preview image data on the displaying section;
a function to transfer reprocessing information imputed by the imputing section with respect to the preview image to the information processing section;
a function to process the processed image data based on the reprocessing information to make a print image data;
a function to transfer the print image data to the printing section;
a function to printing a print image based on the print image data by the printing section.

4. The image forming system of claim 3, wherein the image forming section and the printing section are installed in a image forming apparatus.

5. An image forming method utilizing an image forming system comprising an image forming section, an information processing section and a printing section, the image forming section, the information processing section and the printing section being connected via a network, the image forming section comprising: a scanning section; a storing section; and an operating section having a inputting section, and a displaying section, the image forming method comprising the steps of:
scanning an image on a document to obtain an initial image data;
storing the initial image data into the storing section;
inputting initial processing information by the inputting section;
transferring the initial image data and the initial processing information to the information processing section;
processing the image data based on the initial processing information to make a processed image data by the information processing section;
making a preview image data based on the processed image data by the information processing section;
transferring the preview image data to the image forming section;
displaying a preview image based on the preview image data on the displaying section;
inputting reprocessing information with respect to the preview image by the inputting section;
transferring the reprocessing information to the information processing section;
processing the processed image data based on the reprocessing information to make a print image data;
transferring the print image data to the printing section;
printing a print image based on the print image data by the printing section.
